(19) United States
(12) Patent Application Publication
(10) Pub. No.: US 2024/0032562 A1
(43) Pub. Date: Feb. 1, 2024

(54) Melt-to-Make Bulk Gummy Form, Method of Making and Method of Using

(71) Applicant: c/o M2M Gummies, LLC, Northampton, MA (US)

(72) Inventors: Sarah C. Walker-McLaughlin, Peterborough, NH (US); Siyue Gao, Northampton, MA (US)

(21) Appl. No.: 18/487,352

(22) Filed: Oct. 16, 2023

Related U.S. Application Data
(63) Continuation of application No. PCT/US2022/071786, filed on Apr. 19, 2022.
(60) Provisional application No. 63/176,586, filed on Apr. 19, 2021.

(51) Int. Cl. A23G 3/50; A23G 3/42; A23G 3/44; A23G 3/34

(52) U.S. Cl. CPC A23G 3/50; A23G 3/42; A23G 3/44; A23G 3/0042

(57) ABSTRACT

Methods for making a storage stable bulk gummy form that is a meltable precursor for making individual serving gummies are disclosed, as well as methods for making individual serving gummies from a meltable and storage stable bulk gummy form.

### RELATED APPLICATIONS

This application is a continuation of International Application No. PCT/US2022/071786, filed on Apr. 19, 2022, which designated the United States and published in English, and which claims the benefit of U.S. Provisional Application No. 63/176,586, filed on Apr. 19, 2021. The entire teachings of the above applications are incorporated herein by reference.

### STATEMENT REGARDING PRIOR DISCLOSURES BY THE INVENTOR OR A JOINT INVENTOR

The publication of “MELT-TO-MAKE BULK GUMMIES—WHOLESALE”, www.heritagecbd.com, 24 Oct. 2020 (2020 Oct. 24) was published by an inventor or joint inventor of the subject application. The publication was published on Oct. 24, 2020, which is less than one year before the effective filing date of Apr. 19, 2021.

### BACKGROUND

Gummies are a popular option for infused products, but can be difficult to manufacture. There is need for a quick and easy option for companies wishing to make infused gummies that can be consistently and uniformly made.

### SUMMARY

The disclosure is based on the discovery of a melt-to-make bulk gummy mix that is shelf stable and formulated with flavors and colors in a form that is convenient for the next step in manufacturing individual serving gummies. The bulk gummy form can be melted and formulated by companies making infused gummies in a convenient manner to consistently manufacture gummies in any size and dose. Methods for making a storage stable bulk gummy form that is a meltable precursor for making individual serving gummies are disclosed, as well as methods for making individual serving gummies from a meltable and storage stable bulk gummy form.

### DETAILED DESCRIPTION

A description of example embodiments follows.

### Methods of Making a Storage Stable Bulk Gummy Form

In one aspect, the disclosure pertains to methods of making a storage stable bulk gummy form that is a meltable precursor for making individual serving gummies. The first step in the method of making the bulk gummy form comprises blooming gelatin (e.g., Bloom strength of from about 180 to about 270, with about 250 being preferred) from beef, pork or fish gelatin in water in a heated kettle with a cover to control water evaporation. The ratio of water to gelatin is sufficient to achieve a water activity in a final bulk gummy form of from about 0.70 to about 0.75. The temperature of the water and gelatin mixture should be controlled so that the gelatin protein does not denature. Preferably, the temperature should be maintained below about 155° F. during the blooming process. The bloom is completed when the gelatin has been dissolved in the water, with no visual clumps or pieces of undissolved gelatin. Any undissolved gelatin present can be removed from the solubilized gelatin before it is incorporated into the sugar mixture.

Gelatin can be used in any form, such as sheets, granulated or powder forms. The Bloom strength can be from about 180 to about 270. Preferably, the gelatin will be powdered gelatin having a Bloom strength of 250. To ensure that the water activity is within the range of about 0.70 to about 0.75, the water to gelatin ratio should be from about 2.0 to about 2.3 with minor adjustments in the water to gelatin ratio to achieve a texture that is elastic and gives a chewy mouthfeel. The amount of gelatin and sugar will affect the water activity. Since water is added only to bloom the gelatin and not added in any other step of the method, water activity will change based on the amount of sugar added. The higher the sugar level, the lower the water activity.

It is desirable to avoid going below about 0.70 water activity in the final bulk gummy form so that it can be melted easily in the next step of making individual serving gummies. Some water is needed in the bulk gummy form to compensate for evaporation that occurs when the individual serving gummies are made. If the water activity of the bulk gummy form falls below 0.70, the melt can become too sticky and difficult to infuse finishing ingredients into the melt and mold.

While the gelatin is blooming, glucose syrup (corn syrup, tapioca syrup) is heated in a kettle to reduce the viscosity of the glucose syrup. Once the viscosity has been reduced to a workable viscosity, cane sugar is added to form a mixture. The mixture is heated for a period of time sufficient to reach the desired temperature of from about 150° F. to about 180° F. The temperature should be controlled to prevent denaturing the gelatin protein when it is added to the sugar and glucose mixture.

For sugar alternatives and for reduced sugar gummies, refer to this article: naturalproductsinsider.com/specialty-nutrients/generating-yummy-gummies.

The bloomed gelatin is then added to the glucose and sugar heated mixture for a period of time to fully incorporate the ingredients. At this stage, the mixture can be further processed to add one or more other ingredients, such as but not limited to acidulants, preservatives, flavoring agents, coloring agent, isolates, distillates, extracts, functional ingredients. Functional ingredients that are usually administered in a supplement form (vitamin, minerals, melatonin, L-Theanine, caffeine). While one or more of these ingredients are optional in the bulk gummy mix, the customer making the individual serving gummies from the bulk gummy form will need to incorporate one or more of these other ingredients into the melt to make a finished product to meet the needs of the consumer.

If one or more other ingredients are to be incorporated into the bulk gummy mix, they should be added after the bloomed gelatin has been added to the glucose/sugar mixture. The timing for adding the other ingredients will depend on the nature of the ingredients and whether they are heat and acid sensitive ingredients (e.g. natural color and flavors). Heat and acid sensitive ingredients should be added at the end of the process. Some functional ingredients should be added to the water along with gelatin to dissolve. The skilled person should be able to ascertain when is the appropriate step in the process for incorporating other ingredients. In one embodiment, the bulk gummy mix does not include other ingredients so that the end user can have the flexibility to add other ingredients of their choice. In another embodiment, the bulk gummy mix comprises at least one or more other ingredients so that the end user does not have to add those ingredients. The end user can add additional ingredients beyond those incorporated into the bulk gummy form.

In one embodiment, tartaric acid can be added to the gelatin and sugar mixture to acidulate the gel and imparts a tart flavor to the gummy mix. Other food grade organic acids can be used as an alternative to tartaric acid, such as but not limited to citric acid, lactic acid, fumaric acid, malic acid. The amount of tartaric acid added to the mixture is from about 1.5% to about 1.8%.

After the gelatin and sugars have been incorporated into a mixture, the sugar content of the gummy mix should be measured. A typical measurement for sugar content is determined by Brix. In one embodiment, the Brix measurement should be from about 74 to about 76, measured at about 21° C. to about 22° C.

The mixture is then poured into a mold to create a gummy form and allowed to cure in the mold for a period of time until the gelatin sets. Once set, the gummy form is demolded and a sample is tested for water activity. The remaining bulk gummy forms produced in the batch are directly vacuum packaged to limit environmental exposure, such as airborne contaminants and humidity. Alternatively, the packaging can comprise a modified atmosphere, for example, the addition of an inert gas such as nitrogen into the package.

The water activity of the bulk gummy form is measured and should be of from about 0.70 to about 0.75 to maintain the safety of the product under storage conditions, as discussed herein. Meters and methods for measuring water activity are well known. For example, a meter for measuring water activity is Aqualab3. An example protocol for measuring water activity is available at metergroup.com/food/articles/?related_product=new-aqualab-3.

The gummy form, in either vacuum sealed packaging or atmosphere modified sealed packaging, is storage stable under dry storage conditions and moderate temperature. Moderate temperature is generally considered to be below about 70° F., preferably from about 50° F. to about 60° F. It is desirable to avoid freezing the bulk gummy form because freezing will deteriorate the gel structure. Because the sugar levels and water activity have been controlled, the vacuum packed gummy form can resist fungal growth, discoloration and other detrimental effects that would deteriorate the product.

The batch size of the gummy mix, as specified by the manufacturer, will determine the number of gummy forms that can be produced in a batch. The ratio of ingredients, water activity and Brix should be maintained to ensure that the gummy form is storage stable.

### Storage Stable Bulk Gummy Form

The disclosure also pertains to a meltable and storage stable bulk gummy form that is a precursor for making individual serving gummies, the bulk gummy form having a water activity of from about 0.70 to about 0.75 and a Brix of about 74 to about 76, measured at about 21° C. to about 22 ° C., wherein the bulk gummy form is packaged under vacuum or modified inert atmosphere.

The shape and size of the bulk gummy form will be determined by the manufacturer and will depend upon factors including but not limited to the ability to melt the gummy form in the next step of making individual serving gummies and convenience for packaging and shipping in an economic manner. The bulk gummy form can be made into any shape. In an embodiment, the shape of the bulk gummy is a square, or a circle that resembles a puck. Any bulk size is contemplated that can be conveniently melted down to make the melt for individual gummies. In an embodiment, the size of the form is about 100 grams, for flexibility in scaling to accommodate different batch sizes. In yet another embodiment, the shape is a puck and the size is about 100 grams and having a diameter of about 2.2 inches and a height of about 1.5 inches.

In one embodiment, the bulk gummy mix does not include other ingredients so that the end user can have the flexibility to add those ingredients of their choice. In another embodiment, the bulk gummy mix comprises at least one or more other ingredients so that the end user does not have to add those ingredients. The end user can add additional ingredients beyond those incorporated into the bulk gummy form such as but not limited to acidulants, preservatives, flavoring agents, coloring agent, isolates, distillates, extracts, functional ingredients such as but not limited to vitamins, minerals, caffeine, melatonin, plant extracts.

While one or more other ingredients are optional in the bulk gummy mix, the customer making the individual serving gummies from the bulk gummy form, made by the methods of this disclosure, will need to incorporate one or more of these ingredients into the melt to make a finished product to meet the needs of the consumer.

Examples of flavors that can be used in the products and methods of the disclosure include but are not limited to apple, grape, cranberry, pomegranate, pear, peach, pineapple, cherry, melon (watermelon, cantaloupe), plum, kiwi, mango, banana, papaya, apricot, acai, citrus fruits including but not limited to lemon, orange, grapefruit and lime; and berries including but not limited to strawberry, blackberry, boysenberry, raspberry, blueberry, currants. In preferred embodiments, the colors and flavors should be from all-natural sources.

### Methods for Making Individual Serving Gummies

The bulk gummy form produced by the methods of the disclosure are used as a bulk intermediate or precursor to create individual serving gummies. Because the bulk gummy form is storage stable and meltable, it provides a convenient starting point for the gummy manufacturer to make individual serving gummies that are consistent in formulation and ingredients.

According to an embodiment, individual serving gummies are made by a method comprising melting the bulk gummy form produced by the method of disclosure to create a melt; optionally incorporating at least one other ingredient into melt; and pouring the melt into individual serving molds and allowing the melt to cure to produce individual serving gummies.

The other ingredients (e.g., coloring, flavoring, functional) can be selected from least one ingredient selected from acidulants, preservatives, flavoring agents, coloring agent, isolates, distillates, extracts, functional ingredients or combination of these ingredients. The other ingredients will be selected by the manufacturer based upon customer preferences. Packaging of the final individual serving gummies is also determined by manufacturer and customer preferences.

In an example embodiment, the bulk gummy form can be melted to make individual serving gummies by performing the following method:

1. prepare a double boiler or preheat a double jacketed kettle;
2. place desired number of bulk gummy forms in a double boiler or kettle and let them melt;
3. when the bulk gummy forms are partially melted, the temperature should be regulated and kept below about 170° F. to prevent degradation of the gelatin;
4. once the bulk gummy forms are fully melted, the finishing (functional) ingredient should be added and mixed in with a whisk and the temperature maintained at between about 160° F. to about 170° F.; and
5. once the mixture is fully homogenized, the gummy mixture is ready to be poured into molds.

### Definitions

As used herein, singular articles such as “a,” “an” and “the,” and similar referents are to be construed to cover both the singular and the plural, unless otherwise indicated herein or clearly contradicted by context.

“About” means within an acceptable error range for the particular value, as determined by one of ordinary skill in the art. Typically, an acceptable error range for a particular value depends, at least in part, on how the value is measured or determined, e.g., the limitations of the measurement system. For example, “about” can mean within an acceptable standard deviation, per the practice in the art. Alternatively, “about” can mean a range of ±20%, ±10%, ±5% or ±1% of a given value. It is to be understood that the term “about” can precede any particular value specified herein.

Bulk is defined herein to mean a size and/or quantity of gummy forms packaged as a unit and offered as a precursor for making a plurality of individual serving gummies. A single gummy form or a plurality of gummy forms produced by the methods of the disclosure fall under the term bulk because they can be melted to make a plurality of individual serving gummies.

Gummy mix is intended to mean the melt comprising the gelatin, sugar and optional finishing ingredients before it is cured into the gummy form.

Gummy form is intended to mean the molded and cured product of the method. The gummy form is an individually molded product. It should be understood that the methods disclosed herein produce a plurality of gummy forms and the number is determinant upon the amount of the gummy mix.

Storage stable is defined herein to mean a gummy form or plurality of gummy forms packaged under vacuum or modified inert atmosphere and stored at a temperature of from about 50° F. to about 70° F. Under these conditions, the gummy form has a shelf life of about six months to about twelve months, preferably in the original packaging. Lower storage conditions are contemplated provided that the gummy form is not frozen.

Precursor or intermediate are intended to be interchangeable terms and are defined herein to mean the gummy form being used as a bulk ingredient to be melted, molded and cured into individual serving gummies.

Individual serving size is intended to cover the final gummy product of any size or shape and consumed by an individual in an amount of 1 or multiple gummies. For example, the size of the gummy can be from about 1 gram to about 6 grams. It should be appreciated that the serving size and shape are factors determined by the gummy manufacturer based on manufacturer and customer preferences.

Brix is defined herein to mean the value on the Brix scale representing the amount of dissolved sugar solids in a liquid via its specific gravity. One-degree brix is equivalent to 1 gram of sucrose in 100 grams of solution. Brix can be measured a number of different ways, including but not limited to, brix meter, refractometer, digital density meter, hydrometer and pycnometer.

Distillate is a refined oil form of cannabinoid extract from hemp/marijuana plant, isolate refers to the pure crystals form of a specific cannabinoid, (CBD, THC, etc.). Oil-soluble and water-soluble functional ingredients can be incorporated into the gummy matrix, which include but are not limited to Cannabis/CBD extracts, THC, minerals and vitamins, amino acids, caffeine, melatonin. A preferred ingredient that can be incorporated into the bulk gummy form is cannabis or extract thereof. Any of these can be added to the bulk gummy form, for example, in an amount of extract at the request of the customer (size of the finished gummy and dosage per serving).

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of making a storage stable bulk gummy form that is a meltable precursor for making individual serving gummies, comprising:
a) blooming gelatin having a bloom strength of from about 180 to about 270 and water in a heated kettle, wherein the ratio of water to gelatin is sufficient to achieve a water activity in a final bulk gummy form of from about 0.70 to about 0.75;
b) heating glucose syrup in a kettle to reduce the viscosity of the glucose syrup;
c) adding sucrose to the heated glucose syrup to form a sugar mixture;
d) adding the bloomed gelatin to the sugar mixture;
e) optionally incorporating at least one other ingredient into the mixture of d);
f) pouring the mixture of e) into a mold to create a bulk gummy form and allowing the molded mixture to cure, wherein the mixture has a Brix of about 74 to about 76, measured at about 21° C. to about 22° C.; and
g) demolding the bulk gummy form and directly packaging the bulk gummy form under vacuum or modified inert atmosphere, to produce a storage stable bulk gummy form that is a meltable precursor for making individual serving gummies.

2. The method of claim 1, wherein the bulk gummy form is in the shape of a puck.

3. The method of claim 1, wherein the bulk gummy form is about 100 grams.

4. The method of claim 1, wherein the other ingredients are selected from acidulants, preservatives, flavoring agents, coloring agent, isolates, distillates, extracts, functional ingredient, or combination of these ingredients.

5. The method of claim 1, wherein the bulk gummy form comprises a flavoring agent, a color agent or combination thereof.

6. The method of claim 1, wherein the packaged bulk gummy form is stored below about to above freezing.

7. The method of claim 1, wherein the ratio of water to gelatin is from about 2.0 to about 2.3.

8. A meltable and storage stable bulk gummy form that is a precursor for making individual serving gummies, the bulk gummy form comprises gelatin, glucose and sucrose and has a water activity of from about 0.70 to about 0.75 and a Brix of about 74 to about 76, measured at about 21° C. to about 22° C., wherein the bulk gummy form is packaged under vacuum or modified inert atmosphere.

9. The bulk gummy form of claim 8, wherein the bulk gummy form is in the shape of a puck.

10. The bulk gummy form of claim 8, wherein the bulk gummy form is about 100 grams.

11. The bulk gummy form of claim 8, wherein the bulk gummy form further comprises at least one other ingredient selected from acidulants, preservatives, flavoring agents, coloring agent, isolates, distillates, extracts, functional ingredient, or combination of these ingredients.

12. The bulk gummy form of claim 11, wherein the bulk gummy form comprises a flavoring agent, a color agent or combination thereof.

13. The bulk gummy form of claim 8, wherein the packaged bulk gummy form is stored below about 70° F. to above freezing.

14. A plurality of bulk gummy forms of claim 8 that are packaged together under vacuum or modified inert atmosphere.

15. A method for making individual serving gummies from a meltable and storage stable bulk gummy form, comprising:
melting the bulk gummy form produced by the method of claim 1 to create a melt;
optionally incorporating at least one other ingredient into melt; and
pouring the melt into individual serving molds and allowing the melt to cure to produce individual serving gummies.

16. The method of claim 15, wherein at least one other ingredient, when present, is selected from acidulants, preservatives, flavoring agents, coloring agent, isolates, distillates, extracts, functional ingredient, or combination of these finishing ingredients.

17. The method of claim 16, wherein the functional ingredient is at least one selected from Cannabis/CBD extracts, THC, minerals and vitamins, amino acids, caffeine, melatonin.

18. An individual serving gummy prepared from the bulk gummy form produced by the method of claim 1.

19. An individual serving gummy produced by the method of claim 15.

20. An individual serving gummy prepared from the bulk gummy form of claim 8.
